(19) United States
(12) Patent Application Publication
(10) Pub. No.: US 2015/0139827 A1
(43) Pub. Date: May 21, 2015

(54) HIGH-POWERED VACUUM MACHINE

(71) Applicant: INSULATION TECHNOLOGY CORPORATION (D/B/A INTEC), Frederick, CO (US)

(72) Inventors: Ryan Dwyer, Thornton, CO (US); Shawn Hurla, Platteville, CO (US); Raymond Lavallee, II, Littleton, CO (US); Brett Renck, Parker, CO (US)

(21) Appl. No.: 14/542,565

(22) Filed: Nov. 15, 2014

Related U.S. Application Data
(63) Continuation-in-part of application No. 29/472,851, filed on Nov. 15, 2013.
(60) Provisional application No. 61/905,132, filed on Nov. 15, 2013.
(60) Provisional application No. 62/064,307, filed on Oct. 15, 2014.

(51) Int. Cl. A47L 5/14; F04D 17/10; F04D 29/054; F04D 29/056; A47L 5/22; A01G 1/12

(52) U.S. Cl. CPC A47L 5/14; A47L 5/22; A01G 1/125; F04D 29/054; F04D 29/056; F04D 17/10
USPC 417/319

(57) ABSTRACT

A vacuum machine is provided, comprising: an engine secured to a frame and having an engine shaft; an impeller coupled to the engine shaft; a shroud surrounding the impeller and having an inlet and an outlet; a disk secured to the frame between the engine and the shroud, the disk having a plurality of spaced-apart notches around its perimeter; and a spring-loaded latch pin secured to the shroud and configured to engage one of the notches when in a first, locking position, and to disengage from the notch when in a pulled-back, unlocked position, thereby permitting the shroud to rotate about the impeller and lock in any of a plurality of positions corresponding to the plurality of notches.

### RELATED APPLICATION DATA

The present application is related to, and claims the benefit of, commonly-assigned and co-pending U.S. Provisional Application Ser. No. 61/905,132, entitled HIGH POWERED VACUUM MACHINE, filed on Nov. 15, 2013, U.S. Provisional Application Ser. No. 62/064,307, entitled HIGH POWERED VACUUM MACHINE, filed on Oct. 15, 2014, and is related to, claims the benefit of, and is a continuation in part of, commonly-assigned and co-pending U.S. application Ser. No. 29/472,851, entitled SERRATED CUTTING BLADE FOR INSULATION VACUUM MACHINE, filed on Nov. 15, 2013, which applications are incorporated herein by reference in their entireties.

### TECHNICAL FIELD

The present invention relates to high-powered vacuum machines.

### BACKGROUND ART

Vacuum machines are used by contractors and homeowners to recycle and/or remove undesirable material (such as insulation, leaves, twigs, and other debris) from the interior and exterior of houses and other buildings. Recycle of insulation is popular when contractors are installing loose fill insulation into walls of new buildings; removal may be required due to damage to the structure, such as from flood or fire, or may be desired during a renovation. Vacuums may also be used to pick up leaves and other yard debris when cleaning yards in autumn. Some vacuums may be used in reverse as blowers to move unwanted items such as leaves and twigs from lawns and streets. In either event, using a vacuum machine provides a safe and efficient method to recycle or remove unwanted items such as insulation from an attic or a floor on which it was over-sprayed and scrubbed off, or debris such as leaves and twigs from a yard. A hose is connected to an inlet of the machine, the other end of which is moved about in the undesirable material to be removed. Rotating vanes or blades on a flywheel within a shroud are connected to the shaft of an engine in the machine to create a suction to pull the undesirable material through the hose and into the machine. The undesirable material is then sent into a collection receptacle, either directly or through another hose connected to an outlet of the machine.

Frequently, debris may be concealed within the undesirable material and not seen by the operator of the machine. If the debris is small enough, it will pass through the machine without incident. However, larger debris, such as scrap wood left during construction, may be small enough to be pulled through the hose but too large to pass through the machine. Typically, then, the debris will enter the impeller in the shroud area. As a result, one or more impeller blades may bend or break creating an unbalanced impeller which, due to its high revolution speed, causes the vacuum to immediately vibrate with catastrophic failure occurring in seconds. Other times the debris may jam between the impeller and vacuum housing causing the impeller to stop which also creates a catastrophic failure. The catastrophic failures typically are a broken engine shaft, often combined with a broken shroud, and irreparable impeller. Repairing a broken engine shaft generally is not done; either a is replacement vacuum is purchased (typical), or a new engine is purchased to replace the current one with additional purchases of a new shroud and impeller. These repairs cannot be done in the field causing significant downtime for the vacuum user.

### SUMMARY OF THE INVENTION

Current vacuum machines are (a) limited in vacuuming power due to placement of the impeller directly on the engine axle, (b) prone to costly catastrophic failures when operated in typical conditions, and (c) limited in function to either vacuum only or blow only, thereby often requiring multiple systems to complete a task. The present invention removes these limitations and provides safeguards to make for a vacuum machine that is more powerful, more robust, and more versatile than what is offered in today's market.

The present invention provides a vacuum machine, comprising: an engine having an engine shaft; a vacuum housing having an inlet and an outlet, the inlet having an inlet filter comprising a circular frame with an inner opening and a set of cross-pieces across the inner opening; an impeller within the vacuum housing. The impeller comprises: an impeller base, either circular in shape or space-aged shaped with six sides alternating between straight or radius ends for three sides, to half moon convex radius for alternating three sides, to reduce weight while providing structural support; an impeller shaft secured to the impeller base, the impeller shaft having first and second end sections with a first diameter and a middle section between the first and second end section with a second diameter larger than the first diameter, the impeller shaft allowing for any length to completely fit the hub assembly of any height of impeller; and a plurality of impeller blade modules spaced apart around, and secured to, the impeller base. Each impeller blade module comprises: a pie-piece shaped flat plate, which may or may not have a triangular piece cut out for weight savings, having two edges; and a side piece extending perpendicularly from each edge to the edge. Each side piece comprises; a back edge; a flat top edge perpendicular to the back edge, which may or may not be flat in two or more planes; and a sloped inner edge. The lower of the planes on the flat top edge may have one or more support piece(s)—circular or any shape—connecting each of the impeller blade modules. The vacuum machine further comprises a is break-away coupler connecting the engine shaft with the second end section of the impeller shaft, the coupler may be solid or a break away coupler; and a hub assembly secured to the vacuum housing around the impeller shaft. The hub assembly comprises: a first set of tapered roller bearings overlapping a portion of the first end section and abutting a first end of the middle section of the impeller shaft; a second set of tapered roller bearings overlapping a portion of the second end section and abutting a second end of the middle section of the impeller shaft; and first and second bearing mounts supporting the first and second tapered roller bearing sets.

### BRIEF DESCRIPTION OF THE DRAWINGS

FIG. 1A is a side view of an embodiment of a vacuum machine of the present invention;

FIG. 1B is a front perspective view of the vacuum machine of FIG. 1A;

FIG. 2 is a side view of a break-away coupler and hub assembly that may be used with the vacuum machine of FIG. 1A;

FIG. 3 is an exploded view of a portion of the break-away coupler of FIG. 2;

FIG. 4A is a side view of the hub assembly of FIG. 2;

FIG. 4B is a close-up top perspective view of the hub assembly of FIG. 2;

FIG. 5 is a cut-away view of the hub assembly of FIG. 2;

FIG. 6 is a top view one embodiment of an impeller that may be used with the vacuum machine of FIG. 1A;

FIG. 7 is a perspective view of an impeller blade module that may be used with the impeller of FIG. 6;

FIG. 8A is a top view another embodiment of an impeller that may be used with the vacuum machine of FIG. 1A;

FIG. 8B is a perspective view the impeller of FIG. 8A;

FIG. 9 is a perspective view of still another embodiment of an impeller that may be used with the vacuum machine of FIG. 1A;

FIG. 10A illustrates a front view of an inlet filter that may be used with the vacuum machine of FIG. 1A;

FIG. 10B illustrates the inlet filter of FIG. 10A in place on the vacuum machine is of FIG. 1A;

FIG. 11A illustrates another embodiment of a vacuum machine of the present invention having a rotatable shroud shown in a first position;

FIG. 11B is a close up view of one embodiment of an outlet module attached to the shroud of FIG. 11A in the first position; and

FIG. 12 illustrates the shroud of FIG. 11A in a second position with an alternative embodiment of an outlet module.

### DETAILED DESCRIPTION OF THE PREFERRED EMBODIMENT

The described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention can be practiced without one or more of the specific details, or with other methods, components and so forth. In other instances, well-known structures, materials, or operations are not shown or described in detail to avoid obscuring aspects of the invention.

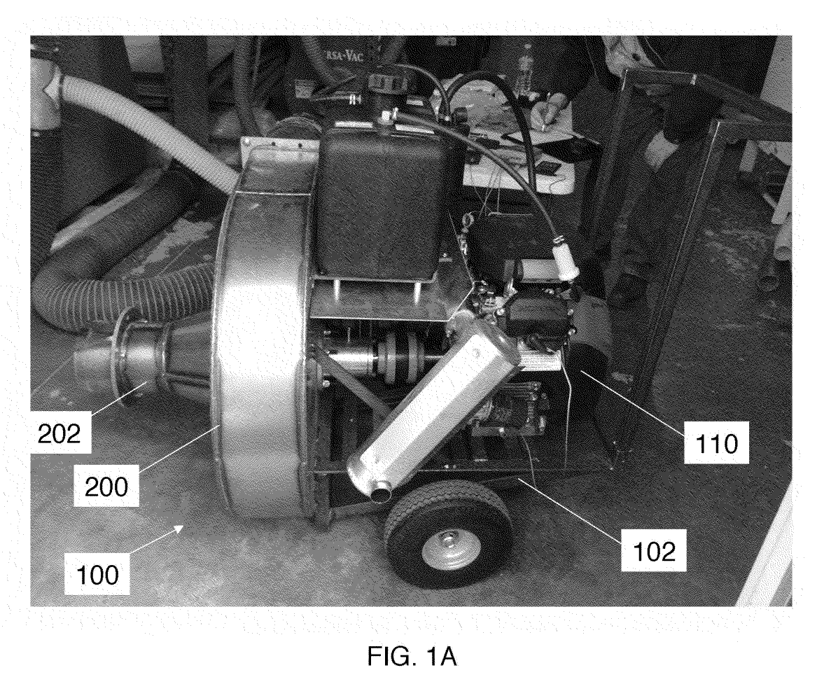

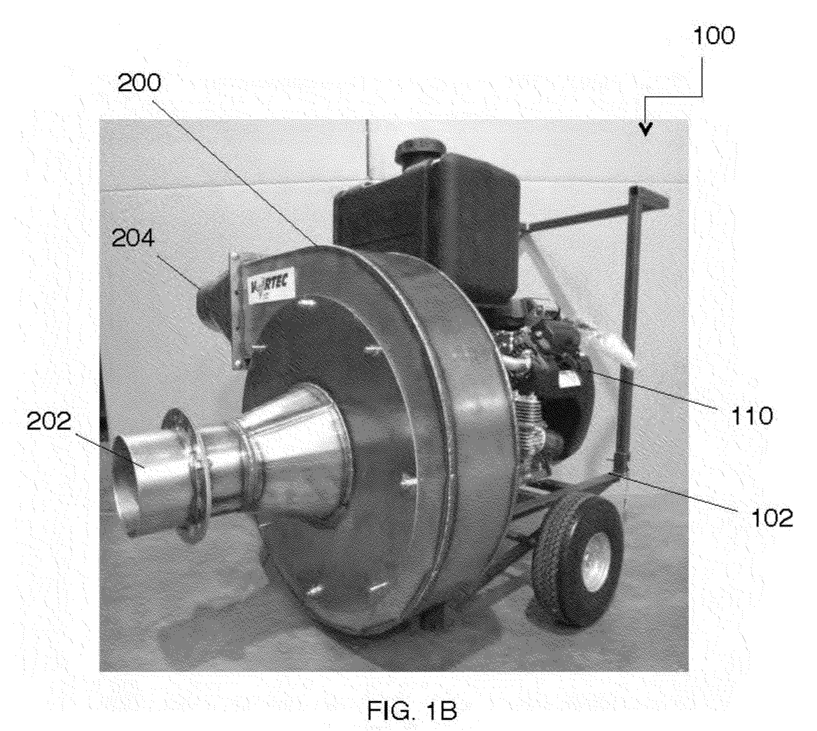

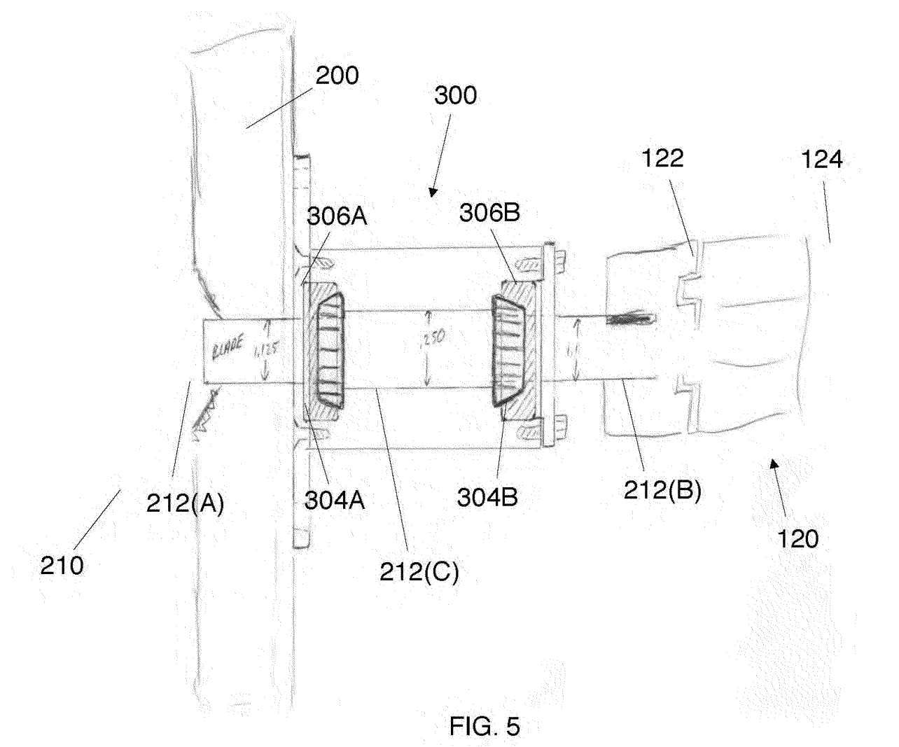

FIGS. 1A and 1B are side and perspective views of a high-powered vacuum machine 100 of the present invention. The machine 100 includes an engine 110 and a vacuum housing 200. The vacuum housing 200 has an inlet 202 and an outlet 204. An impeller 210 (FIG. 5) connected indirectly to an engine shaft is within the housing 200 and, when rotated by the engine 110, creates suction to pull debris through a hose (not shown) connected to the inlet and release it through the outlet into a collection receptacle (not shown), such as a bag. For convenience, the machine 100 may be mounted on a wheeled frame 102.

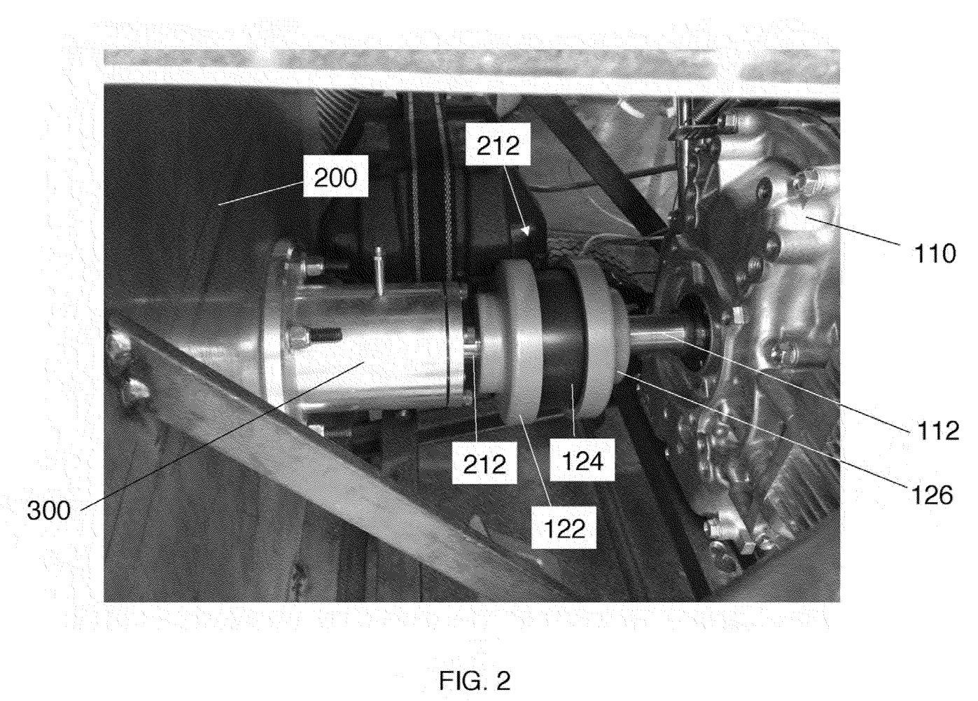

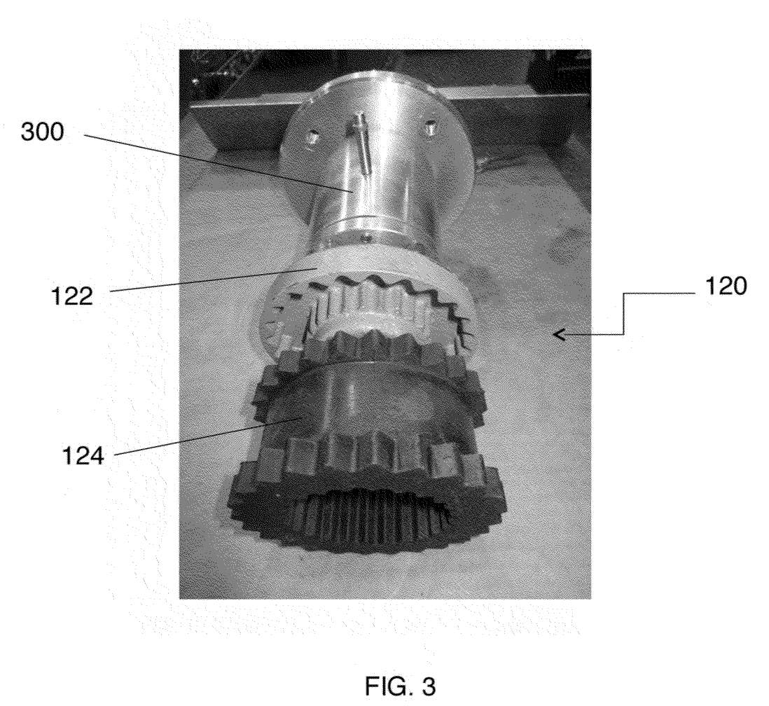

FIG. 2 illustrates the connection of the impeller 210 (within the housing or shroud 200) to the engine 110. An engine shaft 112 is connected to one end of a coupler, such as a break-away coupler 120. A shaft 212, which is connected to the impeller 210, extends through the housing 200 and through a hub assembly 300 and is connected to the other end of the break-away coupler 120. FIG. 3 illustrates two sections of the coupler 120. One outer section 122 connects to the impeller shaft 212. An inner section 124 is designed to break if the torsional force on one of the shafts 112 or 212 exceeds a predetermined amount, such as if debris jams the impeller. A second outer section 126 connects to the engine shaft 112, as shown in FIG. 2.

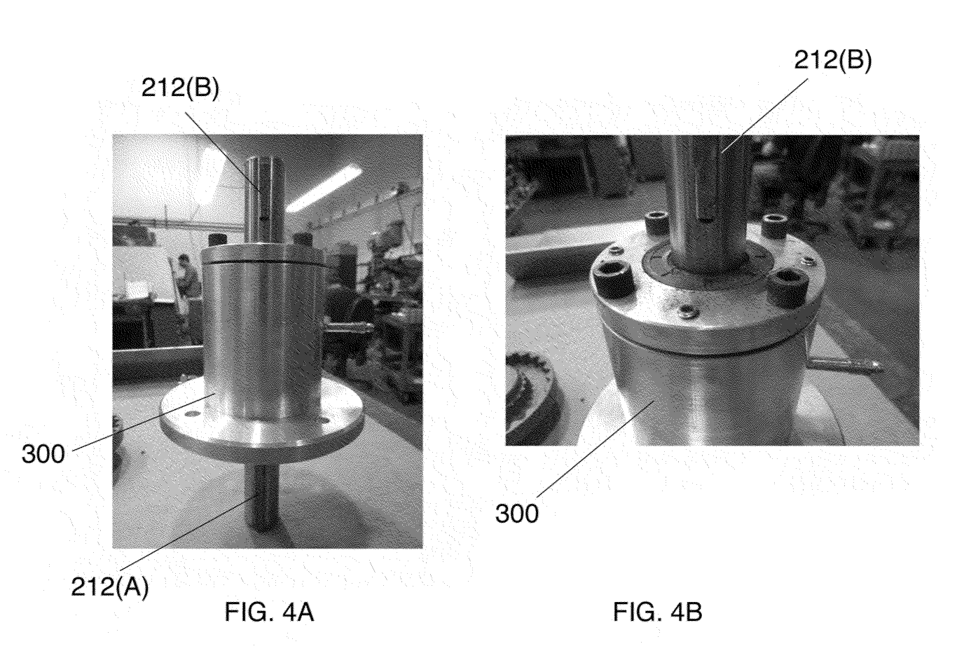

Because the engine and impeller shafts 112 and 212 rotate at high speed, such as approximately 3600 RPM, it is critical that there be no wobble or “play” in the shafts 112, 212; any such imbalance creates a high risk of damage to the impeller 210, the engine 110, or the shafts 112, 212. Consequently, the vacuum machine 100 of the present invention provides a hub assembly 300 around the impeller shaft 212 between the impeller housing 200 and the break-away coupler 120. The hub assembly 300 supports the impeller shaft 212, as illustrated in FIGS. 4A, 4B, and 5. The hub assembly 300 may be bolted onto the impeller housing 200. In the FIGs., the end of the shaft 212 that is connected to the impeller 210 has been labeled 212(A), the end that is connected to the coupler 120 has been labeled 212(B), and the middle section of the shaft 212 that is within the hub assembly has been labeled 212(C). Within the hub assembly 300, the shaft section 212(C) has a diameter slightly larger, such as ⅛ inch, than the diameter of the impeller shaft sections 212(A), 212(B) outside the hub assembly 300. The impeller shaft 212 passes through the hub assembly 300 and is supported at both ends of the hub assembly 300 by tapered roller bearings 304A, 304B. One set of tapered roller bearings 304A overlaps a portion of one impeller shaft section 212A and abutting against one end of the middle section 212(C); the other set of tapered roller bearings 304B overlaps a portion of the impeller shaft section 212B and abutting against the other end of the middle section 212(C). Thus, the tapered roller bearings 304A, 304B are held in position by both the bearing mounts 306A, 306B and the larger shaft section 212(C). As a result, the impeller shaft 212 is held securely and is prevented from moving in any direction other than rotational. That is, the hub assembly with shaft 212 supports the heavy weight, at times up to 40 lbs, of the impeller while connecting to the engine 110 and removing all torsional loads that may otherwise take place on the engine shaft 112 if it were not for this hub assembly 300, shaft 212, and break-away coupler 120.

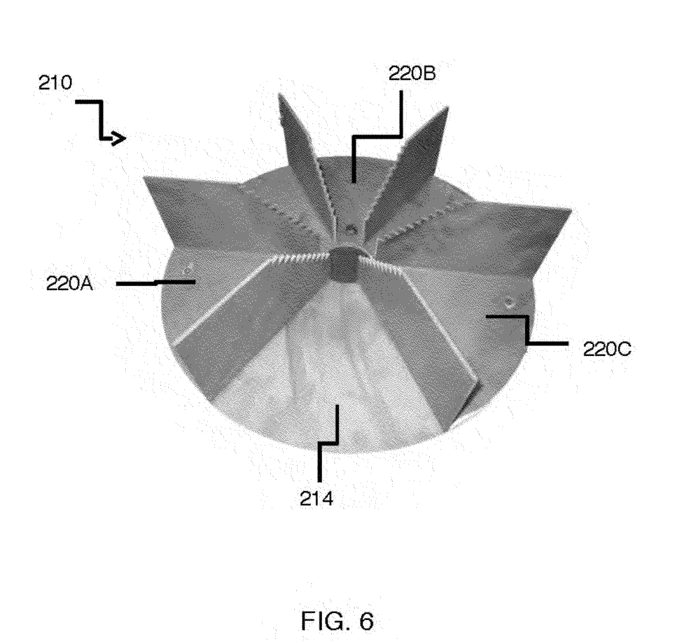

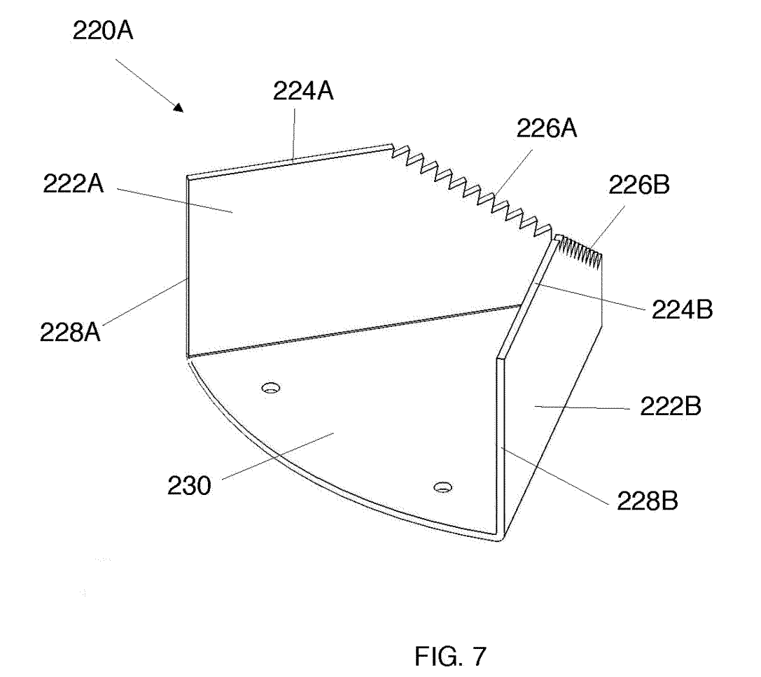

FIGS. 6 and 7 illustrate an embodiment of an impeller 210 that may be used with the vacuum machine 100 of the present invention. The impeller 210 may include an impeller base 214 and two or more precision engineered impeller blade modules, three of which 220A, 220B, 220C are shown in FIG. 6. FIG. 7 illustrates one blade module 220A which may be formed as a pie-piece shaped flat plate 230 with two side pieces 222A, 222B folded perpendicular to the flat plate 230. Alternatively, the side pieces 222A, 222B may be formed separately from the flat plate 230 and secured, such as by welding, perpendicular to the flat plate 230. Each side piece 222A, 222B has a flat top edge 224A, 224B, which is parallel to the flat plate 230, a sloped inner edge 226A, 226B, and a back or outer edge 228A, 228B, which is perpendicular to the flat top edge. The blade modules 220A, 220B, 220C are symmetrically spaced apart around the flywheel 214 and may be bolted or welded, or a combination of bolted and welded, onto the flywheel 214. In the event that a blade is damaged during use, such as from large debris being pulled into the machine 100, it is relatively easy and inexpensive to remove and replace a blade module. And, because no balancing is necessary due to the precision engineered and formed blade modules, the repair may be performed in the field with little down time. If desired, all of the modules may be replaced at the same time.

To improve the performance of the vacuum machine 100, the sloped inner edges 226A, 226B of the blades may be serrated (FIG. 7). Serrations on the inner edges 226A, 226B allow the vacuum machine 100 to more thoroughly cut insulation and small debris before it is ejected through the outlet 204. Such cutting may also reduce the risk that debris will jam the impeller 210.

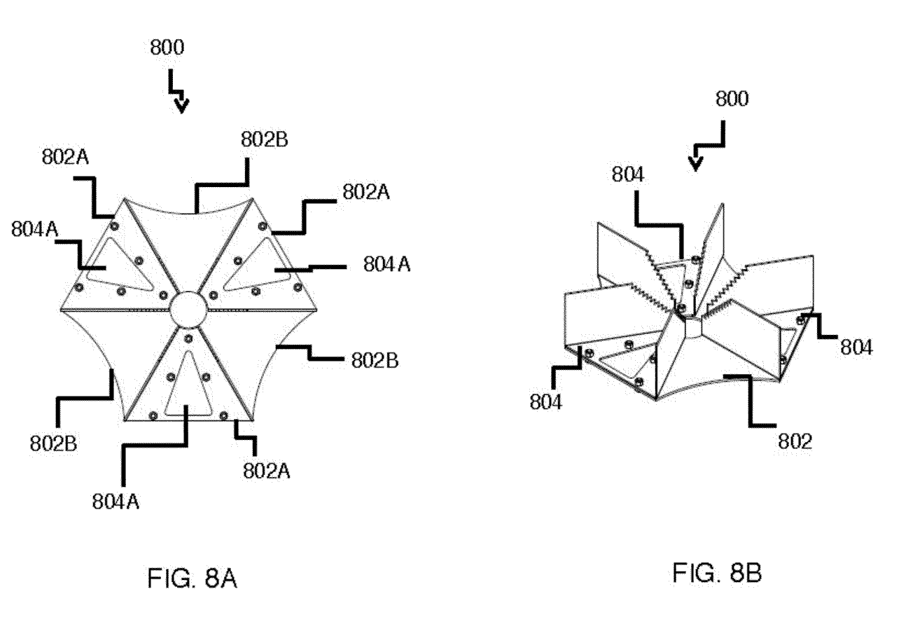

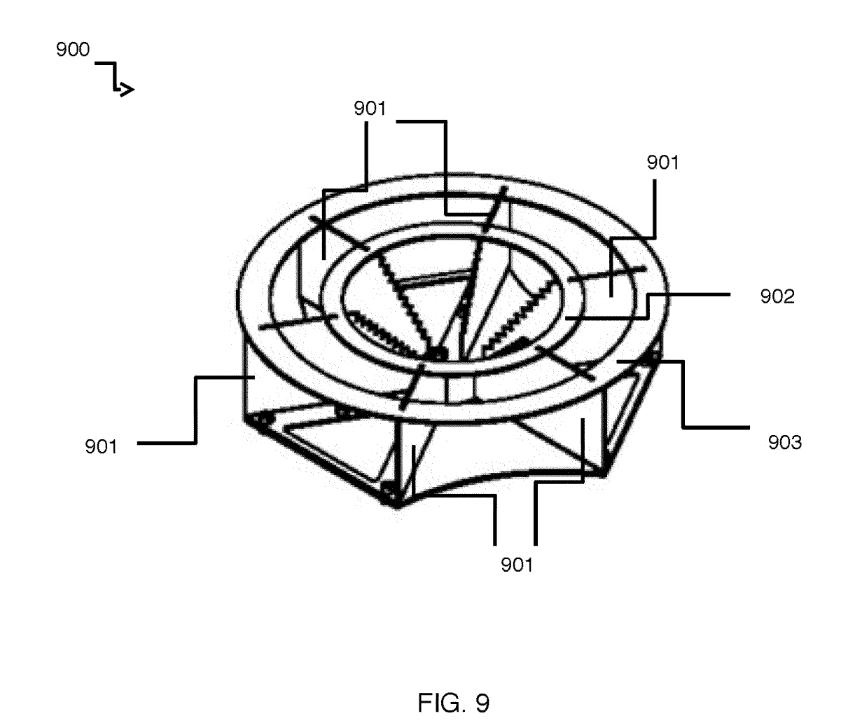

FIGS. 8A, 8B are top and perspective views, respectively, another embodiment of an impeller 800 that may be used with the vacuum machine of the present invention. The impeller 800 may include an impeller base 802 and two or more precision engineered impeller blade modules 804 (three of which are shown in the embodiment of FIGS. 8a, 8B) symmetrically space apart around the impeller base 802. The impeller base 802 may be a six-sided shape having three straight sides 802A alternating with three concave sides 802B to reduce weight, herein referred to as “space-aged shape”. The impeller modules 804 may be solid (as in the embodiment of FIG. 7) or may have material removed creating triangular openings 804A for further weight reduction without reducing strength. In an alternative embodiment, the impeller base 802 may have material removed rather than material being removed from the blade modules 804.

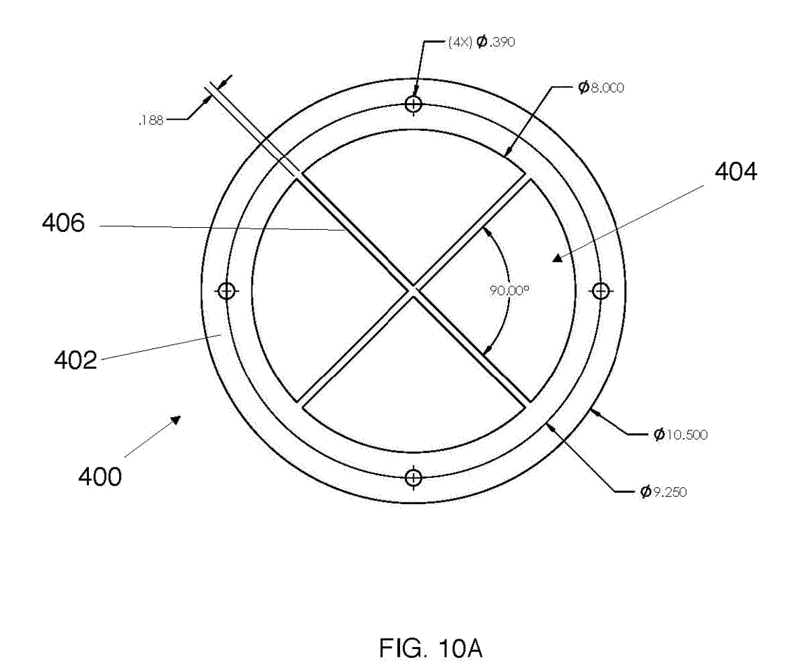

FIG. 9 is a perspective view of still another embodiment of an impeller 900 that may be used with the vacuum machine of the present invention. The impeller 900 includes at least one structural support for the impeller blades 902. An inner ring 904 is secured to each impeller blade 902 at a radial location close to the sloped inner edges. An outer ring 906 is secured to each impeller blade 902 at a location close to the outer radius of impeller 900. The rings 904, 906 can be secured to the blades 902 by various means including welding, precision machining of a receiving and mating end, fasteners, or a combination of these methods. It will be appreciated that the rings 904, 906 may be replaced with other shapes and configurations to provide structural support for the blades 902 and provide even weight distribution.

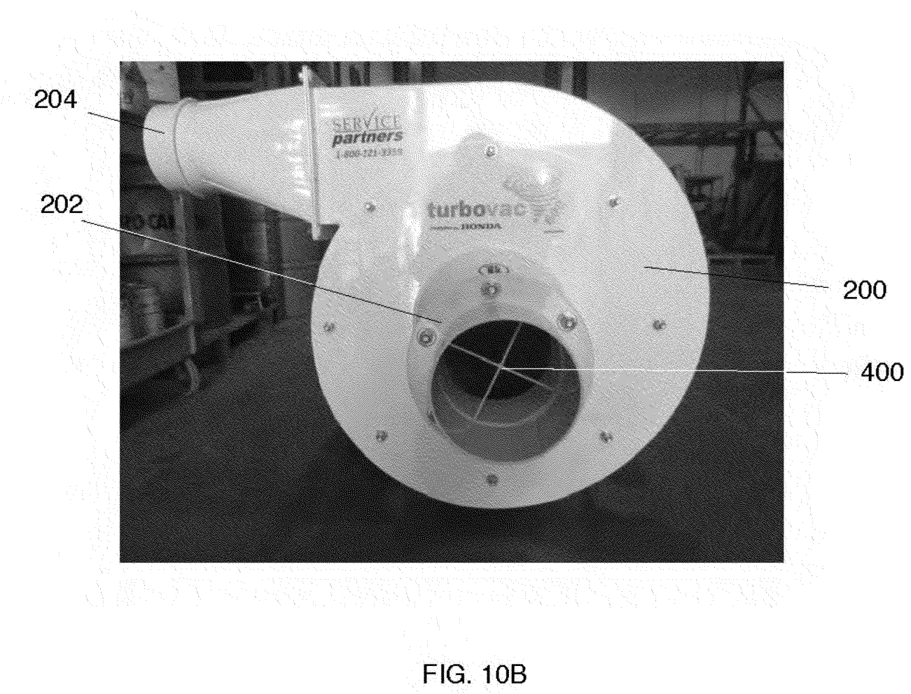

Referring back to FIG. 7, the serrated inner edges 226A, 226B of the blade modules 220A, 220B reduce the risk that small debris will damage the impeller 210. However, an inlet filter 400 (FIGS. 10A and 10B) secured to the inlet 202 of the vacuum housing 200 may be used to prevent larger pieces of debris, such as pieces of 2×4 lumber, from entering the inlet 202. The filter 400 may have a annular frame 402 with an inner opening 404 having a diameter approximately the same as the diameter of the inlet 202. A set of cross-pieces 406 within the inner opening 404 will prevent the larger pieces of debris from passing into the inlet 202. The entire inlet filter 400 (frame 402 and cross-pieces 406) may be formed from a single piece of material. Alternatively, frame 402 and cross-pieces 406 may be formed separately with the cross-pieces 406 being bolted or otherwise secured to the frame 402. The cross-pieces 406 are shown in the FIGs. as being perpendicular two bars intersecting at the center of the opening 404. However, it will be appreciated that other configurations may also be used.

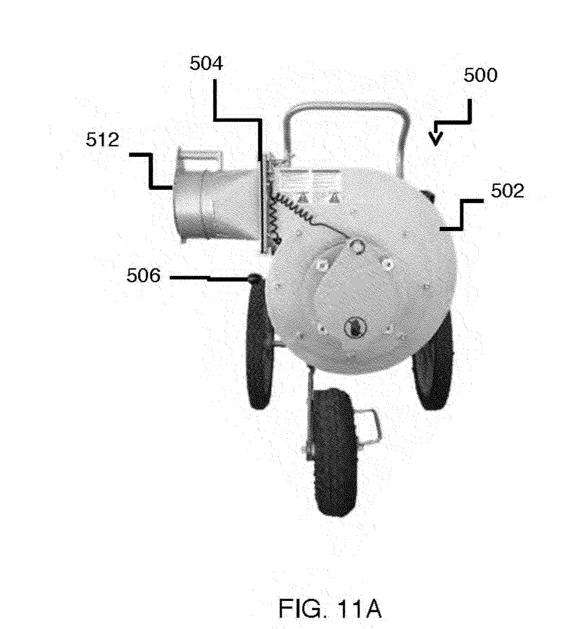

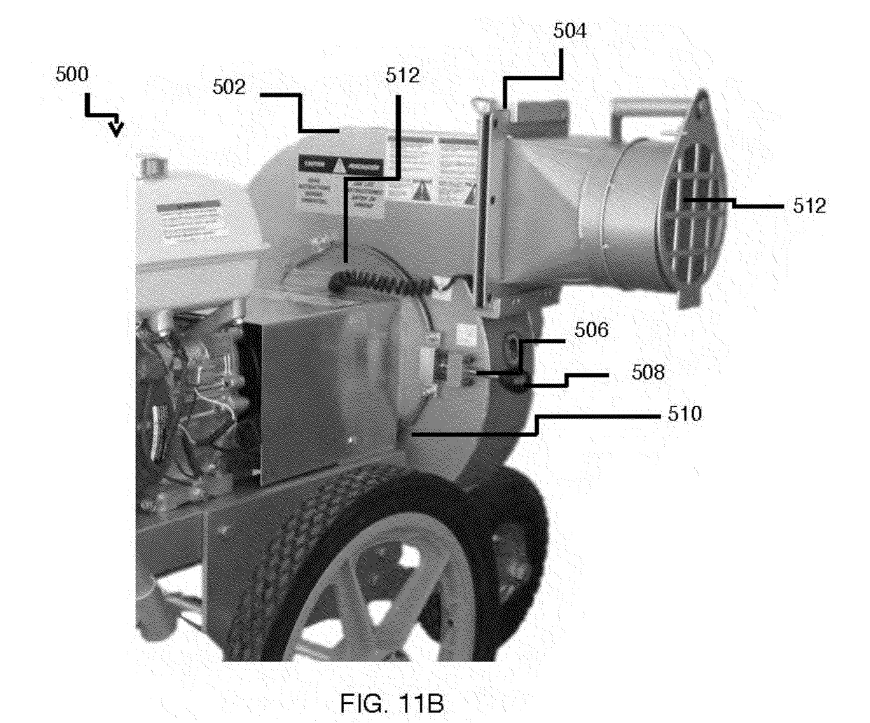

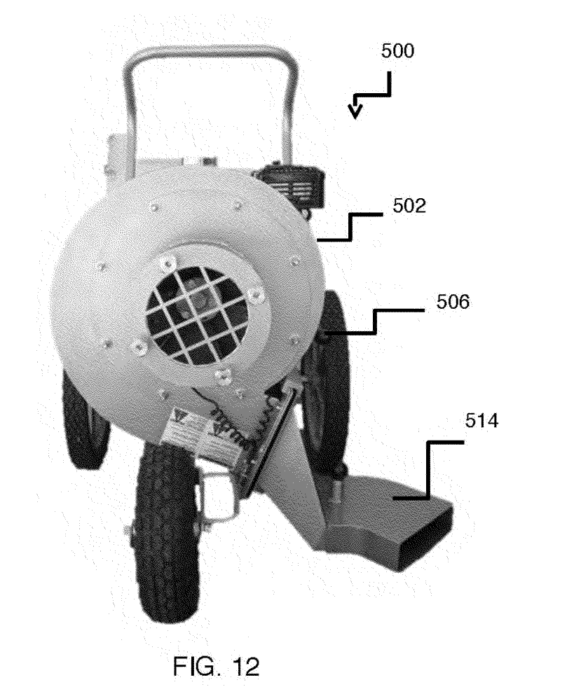

FIGS. 11A, 11B, and 12 illustrate another embodiment of a vacuum machine 500 of the present invention having an impeller shroud or housing 502 that is rotatable about the engine/impeller shaft. The outlet 504 of the shroud 502 may thus be moved into different positions, allowing a single vacuum machine 500 to be deployed in different markets, such as commercial insulation, retail, rental, and lawn is and garden. In FIGS. 11A, 11B, the outlet 504 is shown in a first position on one side of the machine 500 and in FIG. 12, the outlet 504 is shown in a second position on the opposite side of the machine 500 after being rotated approximately 180°. Preferably, the outlet may be locked in any of a number of positions between the first and second positions. A spring-loaded latch pin 506, biased toward the impeller shaft, is attached to the shroud 502 and locks the shroud 502 in place when the latch pin 510 is in a locked or released position. The latch pin 506 may be pulled outward into an unlocked position by a machine operator against the spring from the locked position to release the shroud 502. For convenience, the latch pin 506 may have a handle 508 on the outer end. When the latch pin 506 is in the outward, unlocked position, the shroud 502 and latch pin 510 are free to rotate about the impeller shaft. The operator may then move the shroud 502 into a desired position and release the latch pin 506. When released, the inner end of the pin 506 engages one of several notches 510 radially spaced around the perimeter of an orbital disk 512 secured to a stationary part of the vacuum machine 500, such as on the frame, thereby locking the shroud 502 in place at that location. The spring-loaded pin 506 and corresponding notches 510 represent one method of locking the rotatable shroud 502. It will be appreciated that the shroud 502 may be locked in place using other appropriate means.

The outlet 504 may be fitted with a variety of interchangeable outlet attachments, depending on the use to which the machine 500 is to be put. For example, FIG. 11B illustrates the shroud 502 with one type of outlet notches 512 to which a collection bag may be attached. FIG. 12 illustrates the shroud 502 with a different type of outlet notches 514, which is more appropriate when the machine 500 is used as a blower, such as to remove leaves or other debris from a lawn.

The description of the present invention has been presented for purposes of illustration and description, but is not intended to be exhaustive or limited to the invention in the form disclosed. For example, although the description and accompanying figures are primarily directed towards a vacuum machine used to remove insulation from structures, the features described and illustrated herein may be incorporated into any high-powered vacuum machine. Further, many is modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A vacuum machine, comprising:
an engine having an engine shaft;
a vacuum housing having an inlet and an outlet, the inlet having an inlet filter comprising a circular frame with an inner opening and a set of cross-pieces across the inner opening;
an impeller within the vacuum housing, the impeller comprising:
a circular impeller base;
an impeller shaft secured to the impeller base, the impeller shaft having first and second end sections with a first diameter and a middle section between the first and second end section with a second diameter larger than the first diameter;
a plurality of impeller blade modules spaced apart around, and secured to, the impeller base, each impeller blade module comprising:
a pie-piece shaped flat plate having two edges; and
a side piece extending perpendicularly from each edge, each side piece comprising;
a back edge;
a flat top edge perpendicular to the back edge; and
a sloped inner edge;
a break-away coupler connecting the engine shaft with the second end section of the impeller shaft; and
a hub assembly secured to the vacuum housing around the impeller shaft, the hub assembly comprising:
a first set of tapered roller bearings overlapping a portion of the first end section and abutting a first end of the middle section of the impeller shaft;
a second set of tapered roller bearings overlapping a portion of the second end section and abutting a second end of the middle section of the impeller shaft; and
first and second bearing mounts supporting the first and second tapered roller bearing sets.

2. A vacuum machine, comprising:
an engine secured to a frame and having an engine shaft;
an impeller coupled to the engine shaft;
a shroud surrounding the impeller and having an inlet and an outlet;
a disk secured to the frame between the engine and the shroud, the disk having a plurality of spaced-apart notches around its perimeter; and
a spring-loaded latch pin secured to the shroud and configured to engage one of the notches when in a first, locking position, and to disengage from the notch when in a pulled-back, unlocked position, thereby permitting the shroud to rotate about the impeller and lock in any of a plurality of positions corresponding to the plurality of notches.

3. A vacuum machine, comprising:
an engine secured to a frame and having an engine shaft;
an impeller coupled to the engine shaft;
at least one support ring to provide additional strength to the impeller blades; and
a shroud surrounding the impeller and having an inlet and an outlet.
